(19) United States
(12) Patent Application Publication
(10) Pub. No.: US 2024/0023171 A1
(43) Pub. Date: Jan. 18, 2024

(54) SYSTEMS AND METHODS FOR PROTOCOL CONVERSION FOR LOW POWER WIDE AREA TECHNOLOGIES

(71) Applicant: Verizon Patent and Licensing Inc., Basking Ridge, NJ (US)

(72) Inventors: Jin YANG, Orinda, CA (US); Sudhir PATEL, Boonton, NJ (US); Ye HUANG, San Ramon, CA (US); Susan Wu SANDERS, Bridgewater, NJ (US); Binaben Dipesh PATEL, Franklin Park, NJ (US)

(73) Assignee: Verizon Patent and Licensing Inc., Basking Ridge, NJ (US)

(21) Appl. No.: 17/812,835

(22) Filed: Jul. 15, 2022

(51) Int. Cl. H04W 76/10

(52) U.S. Cl. CPC H04W 76/10

(57) ABSTRACT

In some implementations, a first network device may receive, from a second network device associated with a first core network, a communication associated with a low power wide area (LPWA) technology. The first network device may convert the communication associated with the LPWA technology from a first protocol associated with the first core network to a second protocol associated with a second core network different from the first core network. The first network device may transmit, to a third network device associated with the second core network, the communication associated with the LPWA technology.

### BACKGROUND

User equipment (UE) and similar devices may connect to a wireless network using a variety of technologies. For example, a UE or a similar device may connect to a wireless network using a cellular-based network service, such as a Fourth Generation (4G) network, a Fifth Generation (5G) network, and/or another generation network. In some cases, a UE or a similar device may communicate using a low power wide area (LPWA) technology, such as a narrowband internet-of-things (NB-IoT) technology or a category M (CAT-M) technology. LPWA technologies operate in a limited bandwidth and enable low power consumption and long-range wireless connectivity. Thus, LPWA technologies are often employed in applications requiring long battery life and relatively small data packet sizes, such as IoT communications, machine-to-machine (M2M) communications, or similar applications.

### BRIEF DESCRIPTION OF THE DRAWINGS

FIGS. 1A-1D are diagrams of an example associated with protocol conversion for low power wide area (LPWA) technologies.

FIG. 2 is a diagram of an example environment in which systems and/or methods, described herein, may be implemented.

FIG. 3 is a diagram of an example environment in which systems and/or methods described herein may be implemented.

FIG. 4 is a diagram of example components of a device associated with protocol conversion for LPWA technologies.

FIG. 5 is a flowchart of an example process associated with protocol conversion for LPWA technologies.

### DETAILED DESCRIPTION OF EXAMPLE EMBODIMENTS

The following detailed description of example implementations refers to the accompanying drawings. The same reference numbers in different drawings may identify the same or similar elements.

LPWA technologies, such as NB-IoT technologies or CAT-M technologies, operate in a limited bandwidth and enable low power consumption and long-range wireless connectivity. In some cases, NB-IoT and/or CAT-M technologies may be implemented as part of a wireless communication network, such as part of a 4G and/or LTE network, a 5G network, another next generation network, or the like. For example, when implemented as part of a 5G network, NB-IoT and/or CAT-M communications may be transmitted in a relatively narrow bandwidth that coexists with other 5G network communications via the use of spectrum sharing techniques, such as dynamic spectrum sharing (DSS) or the like. In some implementations, NB-IoT and/or CAT-M communications may be transmitted orthogonal to 5G physical resource blocks (PRB), and/or NB-IoT and/or CAT-M communications may be transmitted at or near the edge of a 5G PRB.

Legacy NB-IoT and/or CAT-M devices traditionally operate using a 4G core network, sometimes referred to an evolved packet core (EPC). However, there is a desire to expand 5G capacity while reducing reliance on the EPC, and thus it would be beneficial for NB-IoT and/or CAT-M devices to operate on a 5G core network (sometimes referred to as 5GC) or other next generation core networks. However, in order for a NB-IoT and/or CAT-M device to operate on a 5GC, radio access network (RAN) devices (sometimes referred to as eNodeBs (eNBs)) associated with the EPC must be updated so that each RAN device can communicate with the 5GC and/or a 5G network device (such as a gNodeB (gNB) or similar 5G network device). An updated eNB that is capable of communicating with the 5GC and/or another 5G network device is sometimes referred to as a next generation eNB (ng-eNB). Updating each eNB to an ng-eNB so that LPWA devices may operate on the 5GC may be time consuming, costly, and impractical due to the numerous eNBs associated with a wireless network. As a result, LPWA communications, such as NB-IoT and/or CAT-M communications, are often relegated to operating on the EPC, resulting in inefficient usage of network resources, congested communication channels and thus increased latency and decreased throughput, and otherwise unreliable LPWA communications.

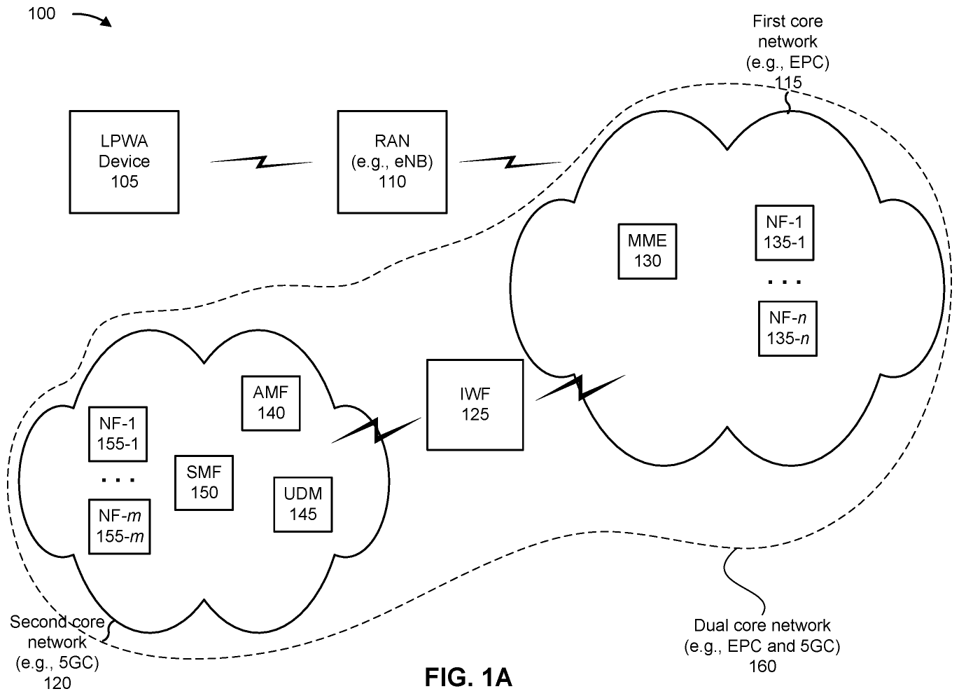

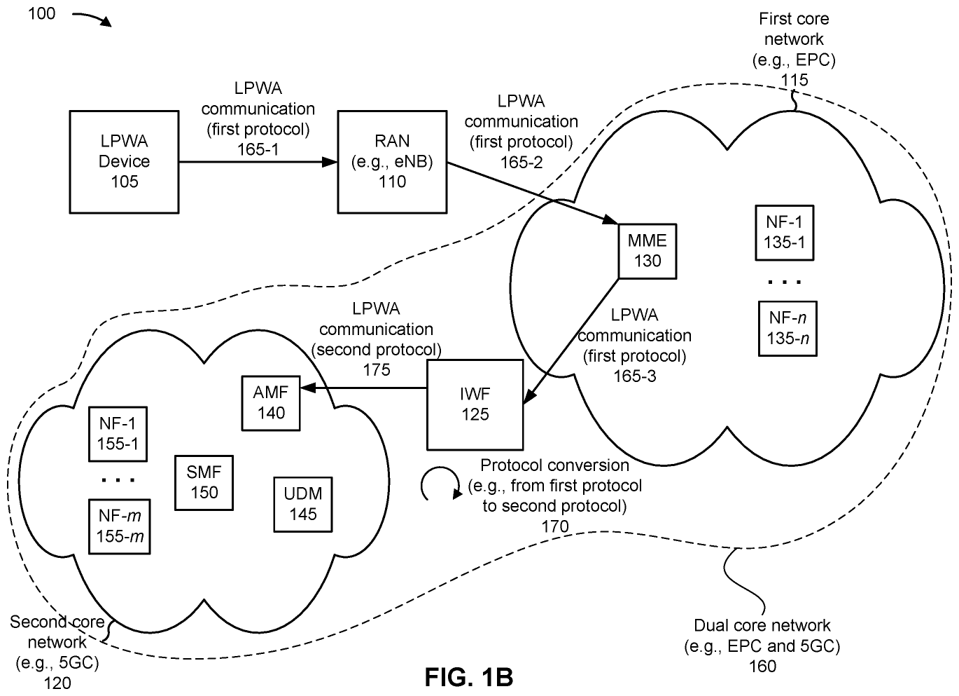

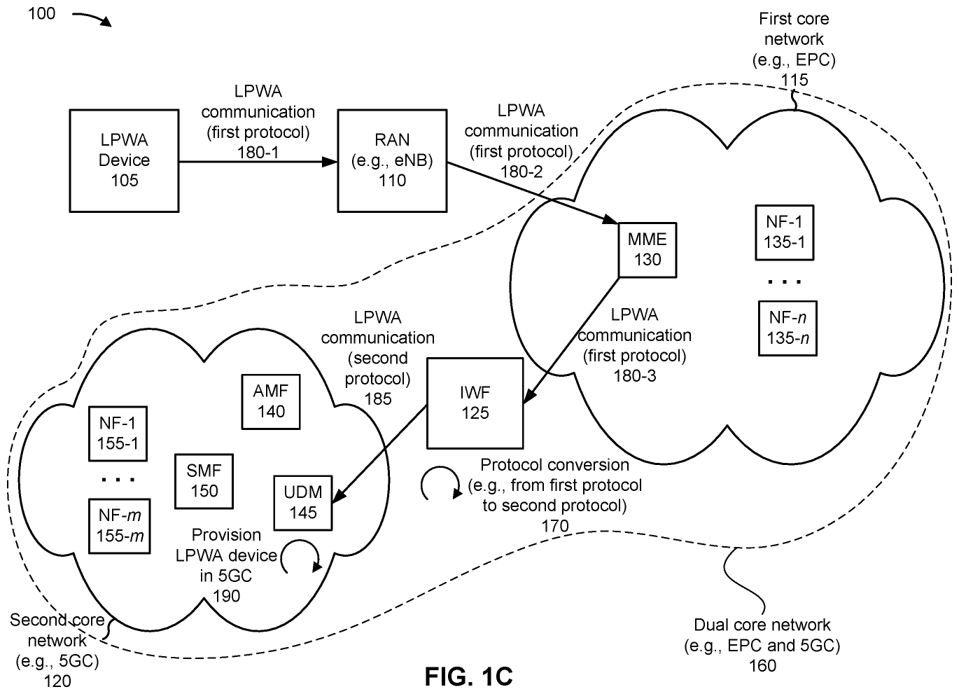

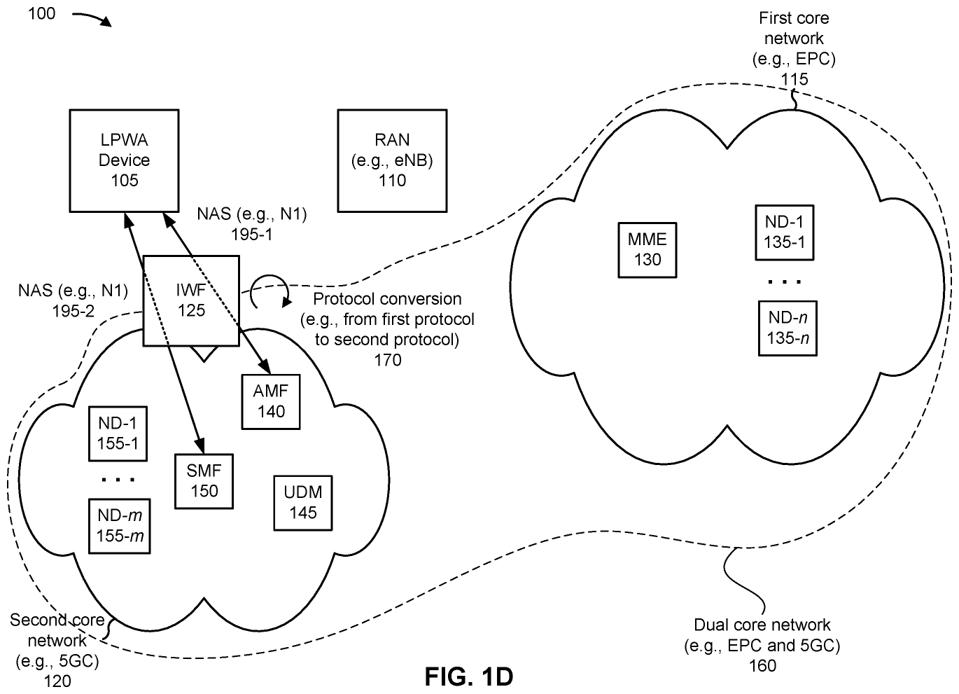

Some implementations described herein enable an interworking function (IWF) device that provides a protocol translation and/or conversion between an EPC component and a 5GC component. In some implementations, the IWF device may carry out a protocol translation between a user equipment (UE) communicating using an LPWA technology and the 5GC. For example, in some implementations, the IWF device may receive a communication associated with an LPWA technology from a network device and/or a network function (NF) associated with an EPC, such as a mobility management entity (MME) device associated with the EPC. The IWF device may convert the LPWA communication from a first protocol (e.g., a 4G protocol) to a second protocol (e.g., a 5G protocol), and transmit to the communication to a network device and/or a NF associated with the 5GC, such as an access and mobility management function (AMF) device, a unified data management (UDM) device, or the like. As a result, LPWA communications, such as NB-IoT and/or CAT-M communications, may operate on the 5GC and/or new LPWA devices (e.g., devices newly connecting to a wireless communication network) may be provisioned in the 5GC, resulting in more efficient usage of network resources, less congested communication channels and thus decreased latency and increased throughput, and otherwise more reliable LPWA communications. This may be more readily understood with reference to FIGS. 1A-1D, described below.

FIGS. 1A-1D are diagrams of an example 100 associated with protocol conversion for LPWA technologies. As shown in FIGS. 1A-1D, example 100 includes an LPWA device 105, a RAN device 110 (e.g., an eNB or a similar network device), a first core network 115 (e.g., an EPC), a second core network 120 (e.g., a 5GC), and an IWF device 125 enabling communication between the first core network 115 and the second core network 120. As shown in FIGS. 1A-1D, the LPWA device 105 may be in communication with the RAN device 110, the RAN device 110 may be in communication with the first core network 115, and the IWF device 125 may be in communication with both the first core network 115 and the second core network 120 and/or with network devices and/or NFs associated with both the first core network 115 and the second core network 120. Although for ease of description the IWF device 125 is shown external to the first core network 115 and the second core network 120, embodiments of the disclosure are not so limited. In some other implementations, the IWF device 125 may form part of the first core network 115, may form part of the second core network 120, or may form part of a dual core network 160, which is described in more detail below.

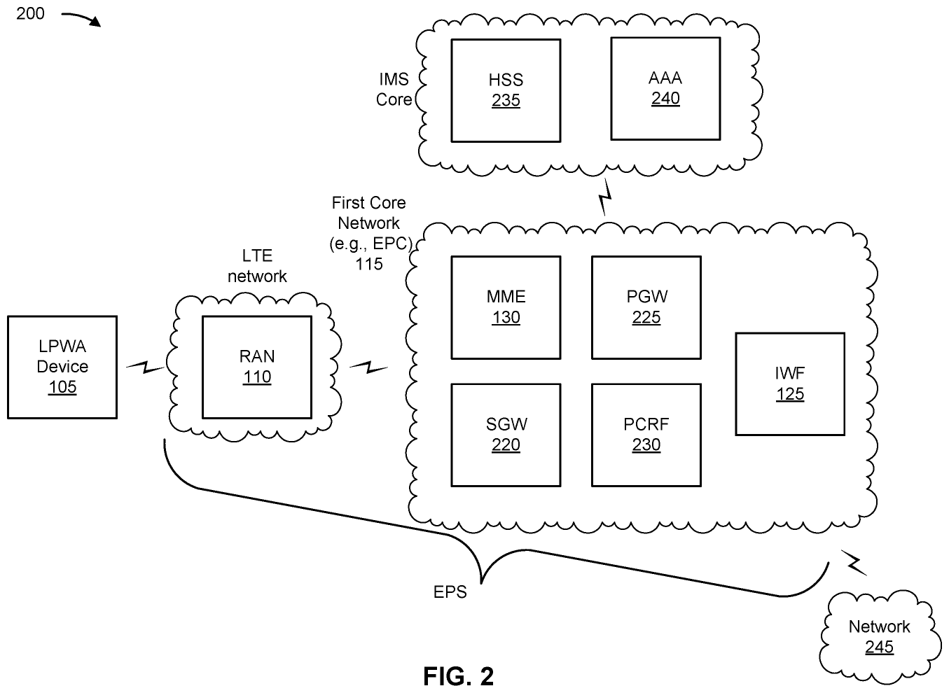

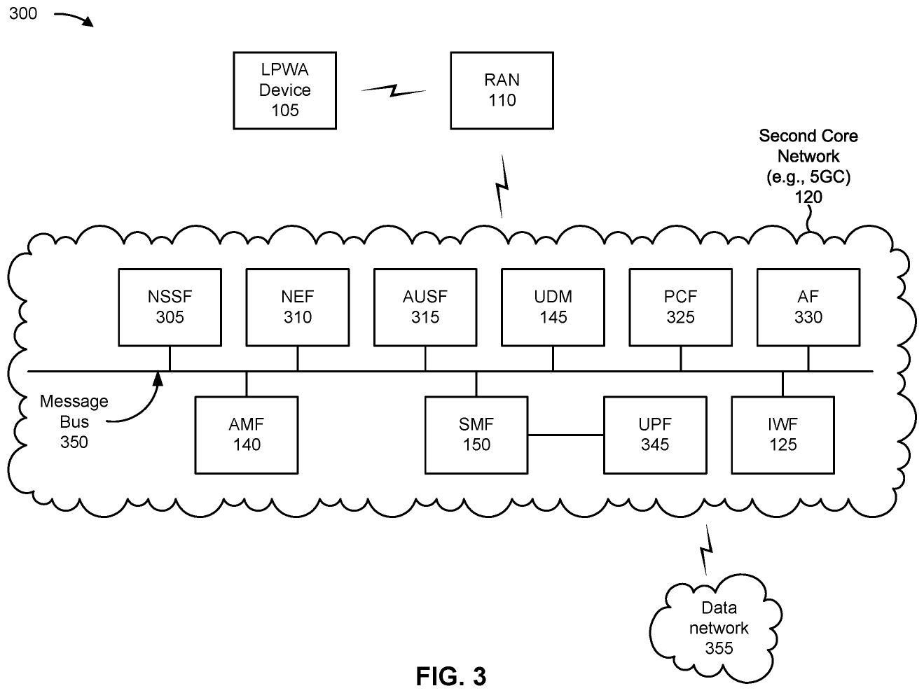

The first core network 115 and/or the second core network 120 may be associated with various network devices and/or various NFs. For example, the first core network 115 (e.g., an EPC) may include an MMV1E device 130 and/or one or more other devices associated with one or more other NFs, shown as NF-1 135-1 through NF-n 135-n, such as one or more of the NFs described below in connection with FIG. 2. The second core network 120 (e.g., a 5GC) may include an AMF device 140, a UDM device 145, a session management function (SMF) device 150, and/or one or more other devices associated with one or more other NFs, shown as NF-1 155-1 through NF-m 155-m, such as one or more of the NFs described below in connection with FIG. 3. Moreover, although for ease of description the first core network 115 is shown as being separate from the second core network 120, embodiments of the disclosure are not so limited. In some other implementations, the first core network 115 and/or NFs thereof and the second core network 120 and/or NFs thereof may form part of a dual core network 160. A dual core network 160 may combine an EPC (e.g., the first core network 115) and a 5GC (e.g., the second core network 120) into a common network or platform.

In some implementations, the IWF device 125 may include hardware and/or software components that serve as an interface between NFs of the first core network 115 and NFs of the second core network 120, such as by providing protocol conversion and/or translation between a first radio access technology (RAT) (e.g., a 4G and/or LTE RAT) and a second RAT (e.g., a 5G RAT). In this way, the LPWA device 105 may communicate with the second core network 120 (e.g., 5GC) via a RAN device 110 associated with the first core network 115 because the IWF device 125 may provide the necessary protocol conversion between a protocol associated with the first core network 115 and a protocol associated with the second core network 120. Beneficially, the LPWA device 105 may operate on the second core network 120 and/or may be provisioned in the second core network 120 even if the RAN device 110 is not capable of communicating directly with the second core network 120 (e.g., even if the RAN device 110 is not an updated RAN device, such as an ng-eNB or the like). This may be more readily understood with reference to FIGS. 1B-1D.

First, as shown in FIG. 1B, and as indicated by reference numbers 165-1 through 165-2, the LPWA device 105 may transmit, to the first core network 115 and using a first communication protocol, an LPWA communication. For example, the LPWA device 105 may communicate with the first core network 115, which may be an EPC, using a NB-IoT and/or a CAT-M technology over a 4G RAT (e.g., by utilizing a spectrum sharing technology or the like to coexist with other 4G communications). More particularly, as shown by reference number 165-1, the LPWA device 105 may transmit the LPWA communication using the first protocol to the RAN device 110, and, as shown by reference number 165-2, the RAN device 110 may transmit the LPWA communication to the first core network 115, and, more particularly, to a network device and/or an NF associated with the first core network 115. For example, the RAN device 110 may transmit the LPWA communication to the MME device 130 or a similar network device or NF associated with the first core network 115.

As shown by reference number 165-3, the network device and/or the NF associated with the first core network 115 (e.g., the MME device 130 in the example depicted in FIG. 1B) may transmit, to the IWF device 125 and using the first communication protocol, the LPWA communication. Put another way, the IWF device 125 may receive, from a network device and/or an NF associated with a first core network 115, a communication associated with the LPWA technology. The IWF device 125 may then translate, convert, or otherwise process the LPWA communication so that the LPWA communication may be communicated to the second core network 120 using a second communication protocol different from the first communication protocol. More particularly, as shown by reference number 170, the IWF device 125 may convert the communication associated with the LPWA technology from a first protocol associated with the first core network 115 (e.g., a protocol associated with a 4G RAT) to a second protocol associated with the second core network 120 different from the first core network 115 (e.g., a protocol associated with a 5G RAT). Following conversion, and as shown by reference number 175, the IWF device 125 may transmit the LPWA communication to the second core network 120 (and, more particularly, to a network device and/or an NF associated with the second core network 120) using the second protocol. For example, in the embodiment depicted in FIG. 1B, the IWF device 125 may transmit the LPWA communication to the AMF device 140.

Although in the embodiment depicted in FIG. 1B the IWF device 125 provides protocol conversion between an MME device 130 associated with the first core network 115 and an AMF device 140 associated with the second core network 120, the disclosure is not so limited. In some other implementations, the IWF device 125 may provide protocol conversion for communications between other network devices and/or NFs without departing from the scope of the disclosure. For example, as shown in FIG. 1C, the IWF device 125 may provide protocol conversion for communications transmitted between the MME device 130 associated with the first core network 115 (e.g., an EPC) and a UDM device 145 associated with the second core network 120 (e.g., a 5GC). More particularly, as indicated by reference numbers 180-1 through 180-2, the LPWA device 105 may transmit, to the first core network 115 and using a first communication protocol, an LPWA communication, which may be performed in a substantially similar manner as described above in connection with reference numbers 165-1 to 165-2. More particularly, as shown by reference number 180-1, the LPWA device 105 may transmit, to the RAN device 110 and using the first communication protocol, the LPWA communication, and, as shown by reference number 180-2, the RAN device 110 may transmit, to the first core network 115 and using the first communication protocol, the LPWA communication. More particularly, the RAN device 110 may transmit the LPWA communication to a network device and/or an NF associated with the first core network 115, such as the MME device 130 or a similar network device or NF associated with the first core network 115.

As shown by reference number 180-3, the network device and/or NF associated with the first core network 115 (e.g., the MME device 130 in the example depicted in FIG. 1C) may transmit, to the IWF device 125 and using the first communication protocol, the LPWA communication. As described above in connection with FIG. 1B, the IWF device 125 may then translate, convert, or otherwise process the LPWA communication so that the LPWA communication may be communicated to the second core network 120, and, more particularly, to a network device and/or an NF associated with the second core network 120. More particularly, as shown by reference number 170, the IWF device 125 may convert the communication associated with the LPWA technology from a first protocol associated with the first core network 115 (e.g., a protocol associated with a 4G RAT) to a second protocol associated with the second core network 120 different from the first core network 115 (e.g., a protocol associated with a 5G RAT). Following conversion, and as shown by reference number 185, the IWF device 125 may transmit, using the second communication protocol, the LPWA communication to the second core network 120 (and, more particularly, to a network device and/or an NF associated with the second core network 120). For example, in the embodiment depicted in FIG. 1C, the IWF device 125 may transmit the LPWA communication to the UDM device 145.

Beneficially, transmitting the LPWA communication to the UDM device 145 may enable provisioning of new LPWA devices (e.g., devices communicating using an NB-IoT technology, a CAT-M technology, or the like, that newly connect to a wireless network) in the 5GC rather than in the EPC. For example, the LPWA communication described in connection with reference numbers 180-1 through 180-3 and 185 may be associated with an initial access communication, a random access communication, or the like, used to establish a connection between the LPWA device 105 and a core network. In such implementations, the LPWA communication may be provided to the UDM device 145, via the IWF device 125, for provisioning the LPWA device 105 within the second core network 120 (e.g., the 5GC). This may beneficially result requiring a smaller EPC that would be necessary if new LPWA devices were required to be provisioned with the EPC. In that regard, and as shown by reference number 190, the UDM device 145 may provision (e.g., register) the LPWA device 105 in the second core network 120. Put another way, in some implementations, the IWF device 125 may provision a UE associated with the LPWA technology (e.g., the LPWA device 105) with the 5GC via the MME device 130 and/or the UDM device 145.

In some implementations, the IWF device 125 may provide protocol conversion associated with a non-access stratum (NAS) connection and/or the IWF device 125 may enable NAS communication (e.g., non-radio signaling) between the LPWA device 105 and one or more network devices and/or NFs associated with the second core network 120. For example, as shown in FIG. 1D, the IWF device 125 may establish a NAS connection between a UE associated with the LPWA technology (e.g., the LPWA device 105) and the AMF device 140 associated with the second core network 120 (e.g., 5GC), as shown by reference number 195-1, and/or the IWF device 125 may establish a NAS connection between the UE and the SMF device 150 associated with the second core network 120, as shown by reference number 195-2. More particularly, the IWF device 125 may establish a NAS connection between a NAS mobility management (NAS-MM) component associated with the LPWA device 105 and a NAS-MM component associated with the AMF device 140, and/or the IWF device 125 may establish a NAS connection between a NAS session management (NAS-SM) component associated with the LPWA device 105 and a NAS-SM component associated with the SMF device 150. Additionally, or alternatively, the NAS connection between the LPWA device 105 and a network device and/or an NF associated with the second core network 120 may be associated with an N1 communication protocol.

By providing protocol conversion between a network device and/or an NF associated with the first core network 115 (e.g., EPC) and a network device and/or a NF associated with the second core network 120 (e.g., 5GC), the IWF device 125 enables devices implementing LPWA technologies (e.g., NB-IoT and/or CAT-M technologies) to operate on the second core network 120 and/or to be provisioned within the second core network 120 without requiring an update to already deployed RAN devices 110, such as eNBs, or the like. Enabling devices implementing LPWA technologies (e.g., NB-IoT and/or CAT-M technologies) to operate on the second core network 120 and/or to be provisioned within the second core network 120 may beneficially result in more efficient usage of network resources, less congested communication channels and thus decreased latency and increased throughput, and otherwise more reliable LPWA communications, as described.

As indicated above, FIGS. 1A-1D are provided as an example. Other examples may differ from what is described with regard to FIGS. 1A-1D. The number and arrangement of devices shown in FIGS. 1A-1D are provided as an example. In practice, there may be additional devices, fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices (e.g., one or more devices) shown in FIGS. 1A-1D may perform one or more functions described as being performed by another set of devices shown in FIGS. 1A-1D.

FIG. 2 is a diagram of an example environment 200 in which systems and/or methods, described herein, may be implemented. As shown in FIG. 2, the environment 200 may include the LPWA device 105, the RAN device 110, the MME device 130, a serving gateway (SGW) device 220, a packet data network gateway (PGW) device 225, a policy and charging rules function (PCRF) device 230, the IWF device 125, a home subscriber server (HSS) device 235, an authentication, authorization, and accounting server (AAA) device 240, and a network 245. Devices of environment 200 may interconnect via wired connections, wireless connections, or a combination of wired and wireless connections.

Some implementations are described herein as being performed within a 4G and/or LTE network for explanatory purposes. Some implementations may be performed within a network that is not an LTE network, such as a third generation (3G) network or a 5G network.

Environment 200 may include an evolved packet system (EPS) that includes an LTE network and/or an EPC (e.g., the first core network 115) that operate based on a third-generation partnership project (3GPP) wireless communication standard. The LTE network may include a RAN that includes one or more RAN devices 110 that take the form of eNBs via which the LPWA device 105 communicates with the EPC. The EPC may include the MME device 130, the SGW device 220, and/or the PGW device 225 to enable the LPWA device 105 to communicate with the network 245 and/or an Internet protocol (IP) multimedia subsystem (IMS) core. In some implementations, the EPC may include the IWF device 125, which may serve as an interface between network devices and/or NFs of the EPC and network devices and/or NFs of another core network (e.g., a 5GC, such as the 5GC described below in connection with FIG. 3), such as by providing protocol conversion and/or translation between a first RAT and a second RAT, as described. The IMS core may include the HSS device 235 and/or the AAA device 240, and may manage device registration and authentication, session initiation, and/or other operations associated with the LPWA device 105. The HSS device 235 and/or the AAA device 240 may reside in the EPC and/or the IMS core.

The LPWA device 105 includes one or more devices capable of communicating with other user devices and/or UEs, the RAN device 110, and/or a network (e.g., network 245). For example, the LPWA device 105 may include a mobile phone (e.g., a smart phone, a radiotelephone, etc.), a laptop computer, a tablet computer, a desktop computer, a handheld computer, a gaming device, a wearable communication device (e.g., a smart wristwatch, a pair of smart eyeglasses, etc.), a sensor, an IoT device, a M2M device, or a similar type of device. The LPWA device 105 may send traffic to and/or receive traffic from another user device and/or the network 245 (e.g., via the RAN device 110, the SGW device 220, and/or the PGW device 225).

The RAN device 110 includes one or more devices capable of transferring traffic, such as audio, video, text, NB-IoT traffic, CAT-M traffic, and/or other traffic, destined for and/or received from the LPWA device 105. In some implementations, the RAN device 110 may include a base station and/or an eNB associated with the LTE network that receives traffic from and/or sends traffic to the network 245 via the SGW device 220 and/or the PGW device 225. Additionally, or alternatively, one or more RAN devices 110 may be associated with a RAN that is not associated with the LTE network. The RAN device 110 may send traffic to and/or receive traffic from the LPWA device 105 via an air interface. In some implementations, the RAN device 110 may include a small cell base station, such as a base station of a microcell, a picocell, or a femtocell.

The MME device 130 includes one or more devices, such as one or more server devices, capable of managing authentication, activation, deactivation, and/or mobility functions associated with the LPWA device 105. In some implementations, the MME device 130 may perform operations relating to authentication of the LPWA device 105. Additionally, or alternatively, the MME device 130 may facilitate the selection of a particular SGW device 220 and/or a particular PGW device 225 to provide traffic to and/or from the LPWA device 105. The MME device 130 may perform operations associated with handing off the LPWA device 105 from a first RAN device 110 to a second RAN device 110 when the LPWA device 105 is transitioning from a first cell associated with the first RAN device 110 to a second cell associated with the second RAN device 110. The MME device 130 may facilitate communication of the LPWA device 105 with another RAT, such as a 5G RAT, and/or with another core network, such as a 5GC, by transmitting communications associated with the LPWA device 105 to the IWF device 125, as described in connection with FIGS. 1B and 1C. Additionally, or alternatively, the MME device 130 may select another MME device (not pictured), to which the LPWA device 105 should be handed off (e.g., when the LPWA device 105 moves out of range of the MME device 130).

The SGW device 220 includes one or more devices capable of routing packets. For example, the SGW device 220 may include one or more data processing and/or traffic transfer devices, such as a gateway, a router, a modem, a switch, a firewall, a network interface card (NIC), a hub, a bridge, a server device, an optical add/drop multiplexer (OADM), or any other type of device that processes and/or transfers traffic. In some implementations, the SGW device 220 may aggregate traffic received from one or more RAN devices 110 associated with the LTE network, and may send the aggregated traffic to the network 245 (e.g., via the PGW device 225) and/or other network devices associated with the EPC and/or the IMS core. The SGW device 220 may receive traffic from the network 245 and/or other network devices, and may send the received traffic to the LPWA device 105 via the RAN device 110. Additionally, or alternatively, the SGW device 220 may perform operations associated with handing off the LPWA device 105 to and/or from an LTE network.

The PGW device 225 includes one or more devices capable of providing connectivity for the LPWA device 105 to external packet data networks (e.g., other than the depicted EPC and/or LTE network). For example, the PGW device 225 may include one or more data processing and/or traffic transfer devices, such as a gateway, a router, a modem, a switch, a firewall, a NIC, a hub, a bridge, a server device, an OADM, or any other type of device that processes and/or transfers traffic. In some implementations, the PGW device 225 may aggregate traffic received from one or more SGW devices 220, and may send the aggregated traffic to the network 245. Additionally, or alternatively, the PGW device 225 may receive traffic from the network 245, and may send the traffic to the LPWA device 105 via the SGW device 220 and the RAN device 110. The PGW device 225 may record data usage information (e.g., byte usage), and may provide the data usage information to the AAA device 240.

The PCRF device 230 includes one or more devices, such as one or more server devices, capable of providing policy control decision and flow-based charging control functionalities. For example, the PCRF device 230 may provide network control regarding service data flow detection, gating, and/or quality of service (QoS) and flow-based charging, among other examples. In some implementations, the PCRF device 230 may determine how a certain service data flow is to be treated, and may ensure that user plane traffic mapping and treatment is in accordance with a user subscription profile.

The IWF device 125 includes one or more devices, such as one or more server devices, capable of providing protocol translation and/or conversion functionalities. For example, the IWF device 125 may provide protocol conversion between a first protocol associated with a first core network, such as a 4G or LTE protocol associated with an EPC, and a second protocol associated with a second core network, such as a 5G protocol associated with a 5GC. The IWF device 125 may enable non-radio signaling, such as via a NAS connection or the like, between the LPWA device 105 and a network device and/or an NF associated with a 5GC, such as the AMF device 140 and/or the SMF device 150.

The HSS device 235 includes one or more devices, such as one or more server devices, capable of managing (e.g., receiving, generating, storing, processing, and/or providing) information associated with the LPWA device 105. For example, the HSS device 235 may manage subscription information associated with the LPWA device 105, such as information that identifies a subscriber profile of a user associated with the LPWA device 105, information that identifies services and/or applications that are accessible to the LPWA device 105, location information associated with the LPWA device 105, a network identifier (e.g., a network address) that identifies the LPWA device 105, information that identifies a treatment of the LPWA device 105 (e.g., quality of service information, a quantity of minutes allowed per time period, a quantity of data consumption allowed per time period, etc.), and/or similar information. The HSS device 235 may provide this information to one or more other devices of the environment 200 to support the operations performed by those devices.

The AAA device 240 includes one or more devices, such as one or more server devices, that perform authentication, authorization, and/or accounting operations for communication sessions associated with the LPWA device 105. For example, the AAA device 240 may perform authentication operations for the LPWA device 105 and/or a user of the LPWA device 105 (e.g., using one or more credentials), may control access, by the LPWA device 105, to a service and/or an application (e.g., based on one or more restrictions, such as time-of-day restrictions, location restrictions, single or multiple access restrictions, read/write restrictions, etc.), may track resources consumed by the LPWA device 105 (e.g., a quantity of voice minutes consumed, a quantity of data consumed, etc.), and/or may perform similar operations.

The network 245 includes one or more wired and/or wireless networks. For example, the network 245 may include a cellular network (e.g., a 5G network, an LTE network, a 3G network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown or described in connection with FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of an example environment 300 in which systems and/or methods described herein may be implemented. As shown in FIG. 3, example environment 300 may include the LPWA device 105, the RAN device 110, the second core network 120 (e.g., a 5GC), and a data network 355 (e.g., network 245). Devices and/or networks of example environment 300 may interconnect via wired connections, wireless connections, or a combination of wired and wireless connections.

As described above in connection with FIG. 2, the LPWA device 105 includes one or more devices capable of receiving, generating, storing, processing, and/or providing information, such as information described herein. For example, the LPWA device 105 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, a sensor, an IoT device, an M2M device, or a similar type of device.

As described above in connection with FIG. 2, the RAN device 110 may support, for example, a cellular RAT. In this example, the RAN device 110 may include one or more base stations (e.g., base transceiver stations, radio base stations, node Bs, eNBs, gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the LPWA device 105. The RAN device 110 may transfer traffic between the LPWA device 105 (e.g., using a cellular RAT), one or more base stations or similar network entities (e.g., using a wireless interface or a backhaul interface, such as a wired backhaul interface), and/or the second core network 120 and/or another core network. The RAN device 110 may provide one or more cells that cover geographic areas.

In some implementations, the RAN device 110 may perform scheduling and/or resource management for the LPWA device 105 covered by the RAN device 110 (e.g., the LPWA device 105 covered by a cell provided by the RAN device 110). In some implementations, the RAN device 110 may be controlled or coordinated by a network controller, which may perform load balancing, network-level configuration, and/or other operations. The network controller may communicate with the RAN device 110 via a wireless or wireline backhaul. In some implementations, the RAN device 110 may include a network controller, a self-organizing network (SON) module or component, or a similar module or component. In other words, the RAN device 110 may perform network control, scheduling, and/or network management functions (e.g., for uplink, downlink, and/or sidelink communications of the LPWA device 105 covered by the RAN device 110).

In some implementations, the second core network 120 may include an example functional architecture in which systems and/or methods described herein may be implemented. For example, the second core network 120 may include an example architecture of a 5G next generation (NG) core network included in a 5G wireless telecommunications system (e.g., a 5GC). While the example architecture of the second core network 120 shown in FIG. 3 may be an example of a service-based architecture, in some implementations, the second core network 120 may be implemented as a reference-point architecture and/or a 4G core network (e.g., an EPC), among other examples.

As shown in FIG. 3, the second core network 120 may include a number of functional elements (e.g., a number of NFs). The functional elements and/or devices may include, for example, a network slice selection function (NSSF) device 305, a network exposure function (NEF) device 310, an authentication server function (AUSF) device 315, the UDM device 145, a policy control function (PCF) device 325, an application function (AF) device 330, the AMF device 140, the SMF device 150, a user plane function (UPF) 345, and/or the IWF device 125. These functional elements may be communicatively connected via a message bus 350. Each of the functional elements shown in FIG. 3 is implemented on one or more devices associated with a wireless telecommunications system. In some implementations, one or more of the functional elements and/or devices may be implemented on physical devices, such as an access point, a base station, and/or a gateway. In some implementations, one or more of the functional elements may be implemented on a computing device of a cloud computing environment.

The NSSF device 305 includes one or more devices that select network slice instances for the LPWA device 105 or other UEs. By providing network slicing, the NSSF device 305 allows an operator to deploy multiple substantially independent end-to-end networks potentially with the same infrastructure. In some implementations, each slice may be customized for different services.

The NEF device 310 includes one or more devices that support exposure of capabilities and/or events in the wireless telecommunications system to help other entities in the wireless telecommunications system discover network services.

The AUSF device 315 includes one or more devices that act as an authentication server and support the process of authenticating the LPWA device 105 in the wireless telecommunications system.

The UDM device 145 includes one or more devices that store user data and profiles in the wireless telecommunications system. The UDM device 145 may be used for fixed access and/or mobile access in the second core network 120, and/or may be used to provision (e.g., register) the LPWA device 105 within the second core network 120, as described in connection with reference number 190 in FIG. 1C.

The PCF device 325 includes one or more devices that provide a policy framework that incorporates network slicing, roaming, packet processing, and/or mobility management, among other examples.

The AF device 330 includes one or more devices that support application influence on traffic routing, access to the NEF device 310, and/or policy control, among other examples.

The AMF device 140 includes one or more devices that act as a termination point for NAS signaling and/or mobility management, among other examples. In some implementations, the AMF device 140 may include, and/or may be associated with, a NAS-MM component, as described in connection with reference number 195-1 in FIG. 1D.

The SMF device 150 includes one or more devices that support the establishment, modification, and release of communication sessions in the wireless telecommunications system. For example, the SMF device 150 may configure traffic steering policies at the UPF device 345 and/or may enforce user equipment IP address allocation and policies, among other examples. In some implementations, the SMF device 150 may include, and/or may be associated with, a NAS-SM component, as described in connection with reference number 195-2 in FIG. 1D.

The UPF device 345 includes one or more devices that serve as an anchor point for intraRAT and/or interRAT mobility. The UPF device 345 may apply rules to packets, such as rules pertaining to packet routing, traffic reporting, and/or handling user plane QoS, among other examples.

As described above in connection with FIG. 2, the IWF device 125 includes one or more devices, such as one or more server devices, capable of providing protocol translation or conversion functionalities. For example, the IWF device 125 may provide protocol conversion between a first protocol associated with a first core network, such as a 4G or LTE protocol associated with an EPC, and a second protocol associated with a second core network, such as a 5G protocol associated with a 5GC. The IWF device 125 may enable non-radio signaling, such as a NAS connection or the like, between the LPWA device 105 and a network device and/or an NF associated with a 5GC.

The message bus 350 represents a communication structure for communication among the functional elements. In other words, the message bus 350 may permit communication between two or more functional elements.

The data network 355 includes one or more wired and/or wireless data networks (e.g., network 245). For example, the data network 355 may include an IMS, a PLMN, an LAN, a WAN, an MAN, a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of example environment 300 may perform one or more functions described as being performed by another set of devices of example environment 300.

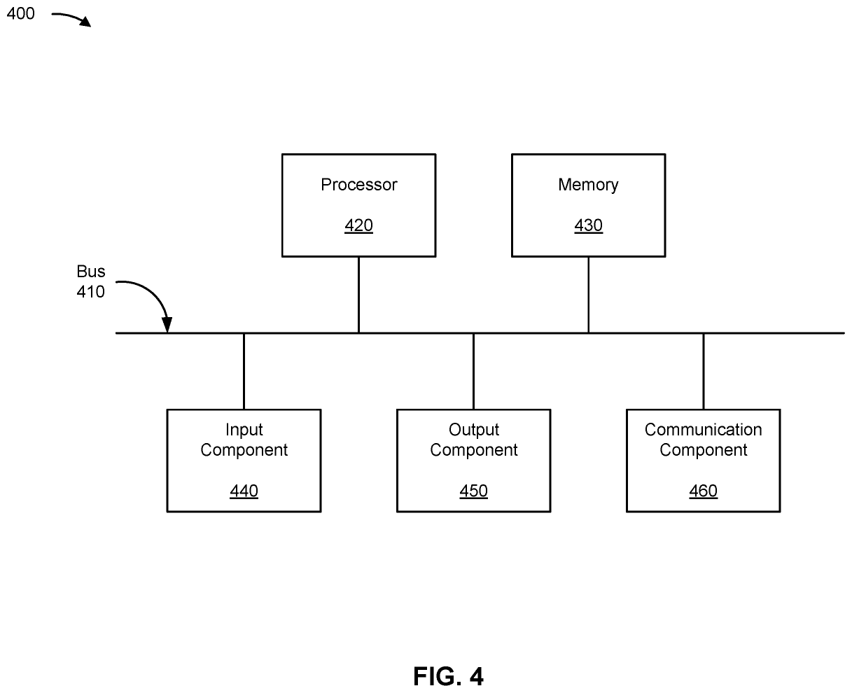

FIG. 4 is a diagram of example components of a device 400 associated with protocol conversion for LPWA technologies. Device 400 may correspond to the LPWA device 105, the RAN device 110, the IWF device 125, the MME device 130, the AMF device 140, the UDM device 145, the SMF device 150, the SGW device 220, the PGW device 225, the PCRF device 230, the HSS device 235, the AAA device 240, the NSSF device 305, the NEF device 310, the AUSF device 315, the PCF device 325, the AF device 330, and/or the UPF device 345. In some implementations, the LPWA device 105, the RAN device 110, the IWF device 125, the MME device 130, the AMF device 140, the UDM device 145, the SMF device 150, the SGW device 220, the PGW device 225, the PCRF device 230, the HSS device 235, the AAA device 240, the NSSF device 305, the NEF device 310, the AUSF device 315, the PCF device 325, the AF device 330, and/or the UPF device 345 may include one or more devices 400 and/or one or more components of device 400. As shown in FIG. 4, device 400 may include a bus 410, a processor 420, a memory 430, an input component 440, an output component 450, and a communication component 460.

Bus 410 may include one or more components that enable wired and/or wireless communication among the components of device 400. Bus 410 may couple together two or more components of FIG. 4, such as via operative coupling, communicative coupling, electronic coupling, and/or electric coupling. Processor 420 may include a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 may include one or more processors capable of being programmed to perform one or more operations or processes described elsewhere herein.

Memory 430 may include volatile and/or nonvolatile memory. For example, memory 430 may include random access memory (RAM), read only memory (ROM), a hard disk drive, and/or another type of memory (e.g., a flash memory, a magnetic memory, and/or an optical memory). Memory 430 may include internal memory (e.g., RAM, ROM, or a hard disk drive) and/or removable memory (e.g., removable via a universal serial bus connection). Memory 430 may be a non-transitory computer-readable medium. Memory 430 stores information, instructions, and/or software (e.g., one or more software applications) related to the operation of device 400. In some implementations, memory 430 may include one or more memories that are coupled to one or more processors (e.g., processor 420), such as via bus 410.

Input component 440 enables device 400 to receive input, such as user input and/or sensed input. For example, input component 440 may include a touch screen, a keyboard, a keypad, a mouse, a button, a microphone, a switch, a sensor, a global positioning system sensor, an accelerometer, a gyroscope, and/or an actuator. Output component 450 enables device 400 to provide output, such as via a display, a speaker, and/or a light-emitting diode. Communication component 460 enables device 400 to communicate with other devices via a wired connection and/or a wireless connection. For example, communication component 460 may include a receiver, a transmitter, a transceiver, a modem, a network interface card, and/or an antenna.

Device 400 may perform one or more operations or processes described herein. For example, a non-transitory computer-readable medium (e.g., memory 430) may store a set of instructions (e.g., one or more instructions or code) for execution by processor 420. Processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry is used instead of or in combination with the instructions to perform one or more operations or processes described herein. Additionally, or alternatively, processor 420 may be configured to perform one or more operations or processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

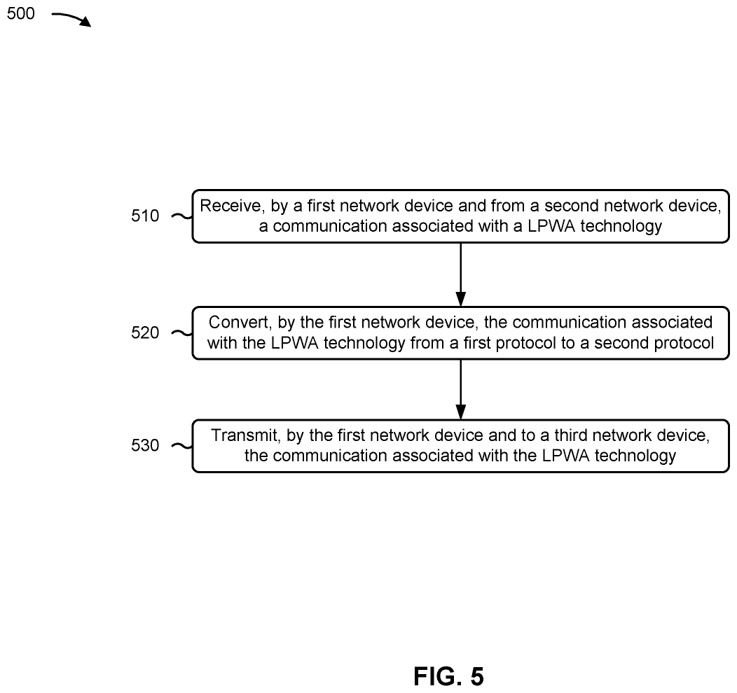

FIG. 5 is a flowchart of an example process 500 associated with protocol conversion for LPWA technologies. In some implementations, one or more process blocks of FIG. 5 may be performed by a first network device (e.g., the IWF device 125). In some implementations, one or more process blocks of FIG. 5 may be performed by another device or a group of devices separate from or including the first network device, such as an LPWA device (e.g., the LPWA device 105), a RAN device (e.g., the RAN device 110), an MME device (e.g., the MME device 130), an AMF device (e.g., the AMF device 140), a UDM device (e.g., the UDM device 145), an SMF device (e.g., the SMF device 150), an SGW device (e.g., the SGW device 220), a PGW device (e.g., the PGW device 225), a PCRF device (e.g., the PCRF device 230), an HSS device (e.g., the HSS device 235), an AAA device (e.g., the AAA device 240), an NSSF device (e.g., the NSSF device 305), an NEF device (e.g., the NEF device 310), an AUSF device (the AUSF device 315), a PCF device (e.g., the PCF device 325), an AF device (e.g., the AF device 330), and/or a UPF device (e.g., the UPF device 345). Additionally, or alternatively, one or more process blocks of FIG. 5 may be performed by one or more components of device 400, such as processor 420, memory 430, input component 440, output component 450, and/or communication component 460.

As shown in FIG. 5, process 500 may include receiving, from a second network device, a communication associated with an LPWA technology (block 510). For example, the first network device may receive, from a second network device, a communication associated with an LPWA technology, as described above. In some implementations, the second network device may be associated with a first core network (e.g., an EPC). Additionally, or alternatively, in some implementations, the first network device is an IWF device (e.g., IWF device 125) associated with the second core network. Moreover, in some implementations, the LPWA technology is one of an NB-IoT technology or a CAT-M technology.

As further shown in FIG. 5, process 500 may include converting the communication associated with the LPWA technology from a first protocol to a second protocol (block 520). For example, the first network device may convert the communication associated with the LPWA technology from a first protocol to a second protocol, as described above. In some implementations, the first protocol may be associated with the first core network (e.g., an 4G protocol associated with an EPC), and the second protocol may be associated with a second core network different from the first core network (e.g., a 5G protocol associated with a 5GC).

As further shown in FIG. 5, process 500 may include transmitting, to a third network device, the communication associated with the LPWA technology (block 530). For example, the first network device may transmit, to a third network device, the communication associated with the LPWA technology, as described above. In some implementations, the third network device may be associated with the second core network. For example, the second network device may be an MME device associated with an EPC (e.g., the MME device 130), and the third network device may be one of an AMF device associated with a 5GC (e.g., the AMF device 140) or an UDM device associated with a 5GC (e.g., the UDM device 145).

In some implementations, when the second network device is the MME device associated with the EPC and the third network device is the UDM device associated with a 5GC, process 500 may include provisioning, by the first network device, a UE associated with the LPWA technology (e.g., the LPWA device 105) with the 5GC via the MME device and the UDM device. Additionally, or alternatively, in some implementations, process 500 may include establishing, by the first network device, a NAS connection between a UE associated with the LPWA technology (e.g., the LPWA device 105) and an SMF device associated with the second core network (e.g., the SMF device 150).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a first network device and from a second network device associated with a first core network, a communication associated with a low power wide area (LPWA) technology;
converting, by the first network device, the communication associated with the LPWA technology from a first protocol associated with the first core network to a second protocol associated with a second core network different from the first core network; and
transmitting, by the first network device and to a third network device associated with the second core network, the communication associated with the LPWA technology.

2. The method of claim 1, wherein the LPWA technology is one of a narrowband internet-of-things (NB-IoT) technology or a category M (CAT-M) technology.

3. The method of claim 1, wherein the first network device is an interworking function (IWF) device associated with the second core network.

4. The method of claim 1, wherein the second network device is a mobility management entity (MME) device associated with an evolved packet core (EPC) network, and wherein the third network device is an access and mobility management function (AMF) device associated with a fifth generation core (5GC) network.

5. The method of claim 1, wherein the second network device is a mobility management entity (MME) device associated with an evolved packet core (EPC) network, and wherein the third network device is a unified data management (UDM) device associated with a fifth generation core (5GC) network.

6. The method of claim 5, further comprising provisioning, by the first network device, a user equipment (UE) associated with the LPWA technology with the 5GC via the MME device and the UDM device.

7. The method of claim 1, further comprising establishing, by the first network device, a non-access stratum (NAS) connection between a user equipment (UE) associated with the LPWA technology and a session management function (SMF) device associated with the second core network.

8. A first network device, comprising:
one or more processors configured to:
receive, from a second network device associated with a first core network, a communication associated with a low power wide area (LPWA) technology;
convert the communication associated with the LPWA technology from a first protocol associated with the first core network to a second protocol associated with a second core network different from the first core network; and
transmit, to a third network device associated with the second core network, the communication associated with the LPWA technology.

9. The first network device of claim 8, wherein the LPWA technology is one of a narrowband internet-of-things (NB-IoT) technology or a category M (CAT-M) technology.

10. The first network device of claim 8, wherein the first network device is an interworking function (IWF) device associated with the second core network.

11. The first network device of claim 8, wherein the second network device is a mobility management entity (MME) device associated with an evolved packet core (EPC) network, and wherein the third network device is an access and mobility management function (AMF) device associated with a fifth generation core (5GC) network.

12. The first network device of claim 8, wherein the second network device is a mobility management entity (MME) device associated with an evolved packet core (EPC) network, and wherein the third network device is a unified data management (UDM) device associated with a fifth generation core (5GC) network.

13. The first network device of claim 12, wherein the one or more processors are further configured to provision a user equipment (UE) associated with the LPWA technology with the 5GC via the MME device and the UDM device.

14. The first network device of claim 8, wherein the one or more processors are further configured to establish a non-access stratum (NAS) connection between a user equipment (UE) associated with the LPWA technology and a session management function (SMF) device associated with the second core network.

15. A non-transitory computer-readable medium storing a set of instructions, the set of instructions comprising:
one or more instructions that, when executed by one or more processors of a first network device, cause the first network device to:
receive, from a second network device associated with a first core network, a communication associated with a low power wide area (LPWA) technology;
convert the communication associated with the LPWA technology from a first protocol associated with the first core network to a second protocol associated with a second core network different from the first core network; and
transmit, to a third network device associated with the second core network, the communication associated with the LPWA technology.

16. The non-transitory computer-readable medium of claim 15, wherein the LPWA technology is one of a narrowband internet-of-things (NB-IoT) technology or a category M (CAT-M) technology.

17. The non-transitory computer-readable medium of claim 15, wherein the first network device is an interworking function (IWF) device associated with the second core network.

18. The non-transitory computer-readable medium of claim 15, wherein the second network device is a mobility management entity (MME) device associated with an evolved packet core (EPC) network, and wherein the third network device is an access and mobility management function (AMF) device associated with a fifth generation core (5GC) network.

19. The non-transitory computer-readable medium of claim 15, wherein the second network device is a mobility management entity (MME) device associated with an evolved packet core (EPC) network, and wherein the third network device is a unified data management (UDM) device associated with a fifth generation core (5GC) network.

20. The non-transitory computer-readable medium of claim 15, wherein the one or more instructions further cause the first network device to establish a non-access stratum (NAS) connection between a user equipment (UE) associated with the LPWA technology and a session management function (SMF) device associated with the second core network.
